(19) United States
(12) Patent Application Publication
(10) Pub. No.: US 2013/0290295 A1
(43) Pub. Date: Oct. 31, 2013

(54) MAINTAINING FAULT DOMAINS IN A DISTRIBUTED DATABASE

(71) Applicants: Craig A. Soules, San Francisco, CA (US); Alistair Veitch, Mountain View, CA (US); Charles B. Morrey, III, Palo Alto, CA (US); Kimberly Keeton, San Francisco, CA (US)

(72) Inventors: Craig A. Soules, San Francisco, CA (US); Alistair Veitch, Mountain View, CA (US); Charles B. Morrey, III, Palo Alto, CA (US); Kimberly Keeton, San Francisco, CA (US)

(21) Appl. No.: 13/460,802

(22) Filed: Apr. 30, 2012

(51) Int. Cl. G06F 17/30

(52) U.S. Cl. 707/714; 707/770; 707/737; 707/713; 707/E17.017; 707/E17.032

(57) ABSTRACT

In at least some examples, a system includes a distributed database and control logic to enable updates and queries to the distributed database. The control logic applies a plurality of identifiers to the updates and queries to maintain distinct fault domains in the distributed database.

### BACKGROUND

Data mining, analysis and search often make up a substantial portion of enterprise application workloads. Examples of data that are the subject of data mining, analysis, and search include purchase transactions, news updates, web search results, email notifications, hardware or software monitoring observations, and so forth.

Such data is collected into datasets. However, as the sizes of datasets increase, the ability to efficiently access the content of such datasets has become more challenging. Further, controlling the physical layout and fault isolation of such databases has become more challenging.

### BRIEF DESCRIPTION OF THE DRAWINGS

For a detailed description of illustrative examples of the disclosure, reference is now made to the accompanying drawings in which:

FIG. 1 shows a system in accordance with an example of the disclosure;

FIG. 2 shows a system layer architecture in accordance with an example of the disclosure;

FIG. 3 shows another system layer architecture in accordance with an example of the disclosure;

FIG. 4 shows a networked system in accordance with an example of the disclosure;

FIG. 5 shows a pipelined database system in accordance with an example of the disclosure;

FIG. 6 shows components of an example computer system in accordance with the disclosure; and

FIG. 7 shows a method in accordance with an example of the disclosure.

### NOTATION AND NOMENCLATURE

Certain terms are used throughout the following description and claims to refer to particular system components. As one skilled in the art appreciates, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to maintaining distinct fault domains for a distributed database. As used herein, a “distributed database” refers to a data access system in which data tables are stored in distinct storage units (e.g., disks), which may be distributed over separate physical machines, and are accessible by a single logical control layer. As disclosed herein, control logic applies a plurality of identifiers to updates and queries to maintain distinct fault domains for a distributed database. In some examples, a distributed database may be a pipelined database in which a plurality of update processing stages is employed. Utilization of the plurality of update processing stages enables variations in query response time and data freshness. For a pipelined database, the control logic may apply a plurality of identifiers for each update processing stage to maintain distinct fault domains for the pipelined database. As an example, an identifier to maintain fault domains within a distributed database may be applied to each set of updates in an update processing pipeline. In some examples, a set of updates (a batch) may include just a single update, and an identifier is applied to each individual update.

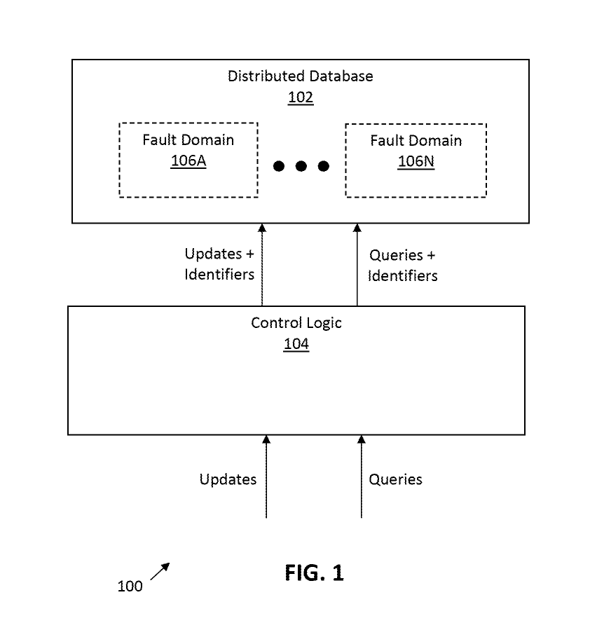

FIG. 1 shows a system 100 in accordance with an example of the disclosure. As shown, the system 100 comprises a distributed database 102 in communication with control logic 104. The distributed database 102 comprises a plurality of fault domains 106A-106N, which corresponds to distinct storage unit groupings that are fault isolated. To create and maintain the fault domains 106A-106N, the control logic 106 applies identifiers to updates and queries for the distributed database 102. The identifiers may be, for example, metadata applied to all or certain updates/queries. Without limitation to other embodiments, the control logic 104 may comprise at least one processor executing instructions to perform the operations of the control logic 104 described herein.

In some embodiments, the distributed database 102 comprises a pipelined database having a plurality of update processing stages, where the plurality of update processing stages enables variations in query response time and data freshness. As an example, the plurality of identifiers may comprise metadata identifiers attached to updates in an update processing pipeline.

In some examples, the control logic 104 assigns different fault domains 106A-106N of the distributed database 102 to different customers or applications. Alternatively, a plurality of the fault domains 106A-106N may be assigned to a single customer or application. Although not required, different fault domains 106A-106N may be associated with different performance and reliability capabilities. Accordingly, the control logic 104 takes performance requests and/or reliability requests into account when assigning one of the fault domains 106A-106N to a customer.

In some examples, the control logic 104 enables distinct domains of the fault domains 106A-106N to be joined. The join operation may correspond to applying one identifier to updates and/or queries to the joined fault domains. Alternatively, the join operation may correspond to applying all identifiers associated with the joined fault domains for updates and/or queries to the joined fault domains. Further, in some examples, the control logic 104 limits visibility of different domains of the fault domains 106A-106N according to a predetermined or customizable visibility scheme. As an example, a domain of the fault domains 106A-106N assigned to a customer may only be visible to (e.g., queried by) that customer. Alternatively, a domain of the fault domains 106A-106N assigned to a customer may be visible according to customer-specific criteria and/or a service-level agreement.

In some examples, the distributed database 102 is associated with a distributed file system, where each of the distinct fault domains 102A-102N is associated with a logical file system within the distributed file system. In such cases, the plurality of identifiers applied to updates and/or queries to maintain the fault domains 106A-106N may correspond to logical file system identifiers associated with the distributed file system. As used herein, a “distributed file system” refers to a file system that stores data and serves users from multiple cooperating computers connected by a computer network. It allows access to files from multiple hosts sharing via a computer network. This makes it possible for multiple users on multiple machines to share files and storage resources. Transparency may be built into a distributed file system, so that files accessed over the network can be treated the same as files on local disk by programs and users. The distributed file system is able to locate stored files and arrange for the transport of the data. As used herein, a “logical file system” refers to a single namespace with a single root inside a distributed file system. A single distributed file system may comprise many logical file systems.

In some examples, the control logic 104 ensures metadata stored or originating in a logical file system that is part of a distributed file system is stored back into that logical file system to enable origin-based data partitioning. Further, the control logic 104 may apply separate migration and backup operations to an origin file system based on its expected fault behavior so that a corresponding domain of the fault domain 106A-106N has the same reliability semantics as the origin file system.

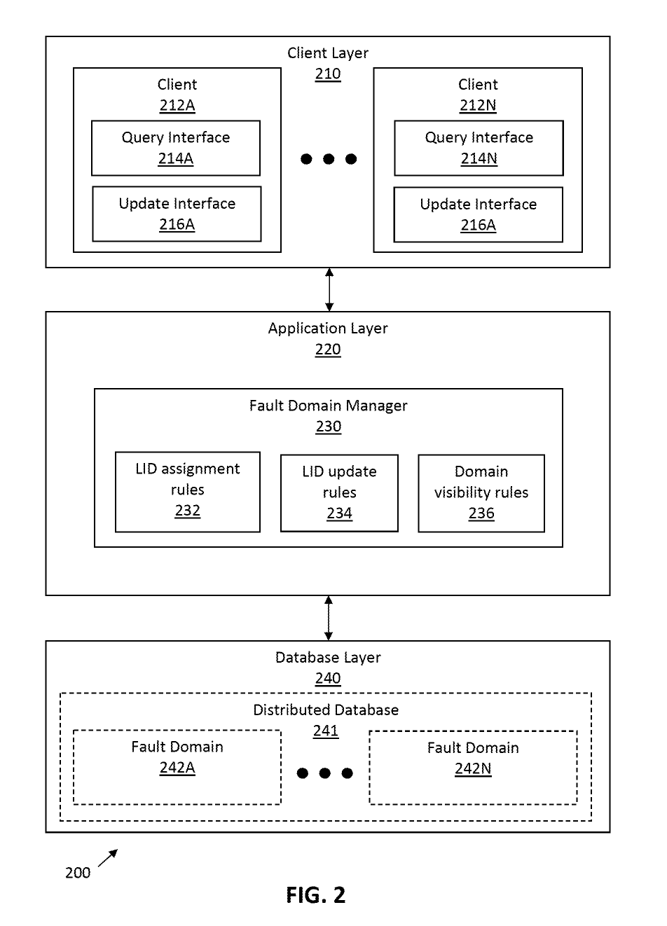

FIG. 2 shows a system layer architecture 200 in accordance with an example of the disclosure. As shown, the architecture 200 comprises a client layer 210 and a database layer 240 in communication with the client layer 210 via an application layer 220. The client layer 210 comprises clients 212A-212N that are able to perform updates or queries to the database layer 240 via the application layer 220. As shown, the database layer 240 comprises a distributed database 241 with distinct fault domains 242A-242N. In some examples, each of the clients 212A-212N comprises a respective query interface 214A-214N and/or a respective update interface 216A-216N. Without limitation to different examples of the architecture 200, some of the clients 212A-212N may comprise only a respective query interface 214A-214N. Meanwhile, others of the clients 212A-212N may comprise only a respective update interface 216A-216N. Further, others of the clients 212A-212N may comprise both a respective query interface 214A-214N and a respective update interface 216A-216N.

In some examples, the query interfaces 214A-214N and/or the update interfaces 216A-216N correspond to a database interface such as open database connectivity (ODBC), a Web browser, or other user interface for network-based communications. Alternatively, the query interfaces 214A-214N and/or the update interfaces 216A-216N may correspond to a user interface for local communication architectures (e.g., if the client layer 210 and the application layer 220 are implemented on the same computer). Regardless of whether the client layer 210 and the application layer 220 are local or remote to each other, the query interfaces 214A-214N enable users to submit queries to the application layer 220. Similarly, the update interfaces 216A-216N enable user to submit updates to the application layer 220.

As shown, the application layer 220 comprises a fault domain manager 230. The fault domain manager 230 comprises logical identifier (LID) assignment rules 232, LID update rules 234, and domain visibility rules 236. The LID assignment rules 232 enable LIDs corresponding to fault domains 242A-242N to be assigned to updates and/or queries to the database layer 240. For example, the LID assignment rules 232 may enable assignment of different fault domains 242A-242N of the database layer 240 to different customers. The LID assignment rules 232 also may account for different performance and reliability capabilities of different fault domains 106A-106N when assigning LIDs associated with the fault domains 106A-106N. As disclosed herein, the LIDs are applied to updates for the database layer 240 to maintain the distinct fault domains 242A-242N and are applied to queries for the database layer 240 to access the distinct fault domains 242A-242N.

The LID update rules 234 enable the LIDs to be updated as needed. For example, the LID update rules 234 may be applied to cause distinct domains of the fault domains 242A-242N to be joined. Alternatively, the LID update rules 234 may be applied to cause joined domains of the fault domains 242A-242N to be disjoined. The LID update rules 234 also may be applied to reassign fault domains 242A-242N to different customers. In such case, the same LID or a different LID may be used for a fault domain that has been reassigned.

The domain visibility rules 236 are applied to limit visibility of different domains of the fault domains 242A-242N according to a predetermined or customizable visibility scheme. As an example, a domain of the fault domains 242A-242N assigned to a customer may only be visible to (e.g., queried by) that customer. Alternatively, a domain of the fault domains 242A-242N assigned to a customer may be visible according to customer-specific criteria (e.g., public, private, or group) and/or a service-level agreement.

In some examples, the rules (e.g., the LID assignment rules 232, the LID update rules 234, and the domain visibility rules 236) applied by the fault domain manager 230 are compatible with a distributed file system, where each of the distinct fault domains 242A-242N is associated with a logical file system within the distributed file system. In such case, the rules applied by the fault domain manager 230 may utilize logical file system identifiers associated with the distributed file system as the LIDs applied to updates and/or queries for the database layer 240.

Further, in some examples, the rules applied by the fault domain manager 230 ensure metadata stored or originating in a logical file system that is part of a distributed file system is stored back into that logical file system to enable origin-based data partitioning. Further, the rules applied by the fault domain manager 230 may separate migration and backup operations to an origin file system based on its expected fault behavior so that a corresponding fault domain has the same reliability semantics as the origin file system. Further, the fault domains 242A-242N may correspond to individual nodes running a distributed file system and updates are partitioned based on the location of the data to which they refer. For example, if the updates refer to metadata for files A, B, and C, then the updates may be partitioned based on which nodes A, B and C reside and may be stored with the respective files.

Further, the rules applied by the fault domain manager 230 may enforce different data access rights for individuals by designation of access conditions in a query. As needed, the rules applied by the fault domain manager 230 may support operations of the application layer 220 to provide different mappings to enable query compatibility for different database types, database objects, and object properties.

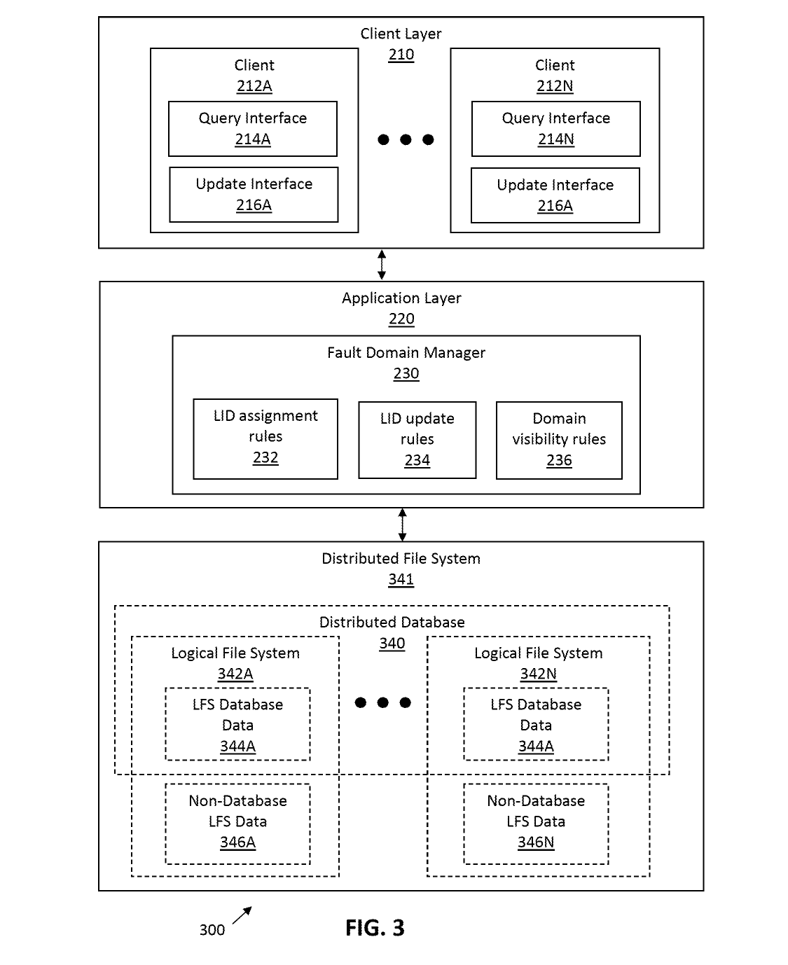

FIG. 3 shows another system layer architecture 300 in accordance with an example of the disclosure. In FIG. 3, the architecture 300 comprises the client layer 210 and the application layer 220 described for system layer architecture 200. For the architecture 300, the application layer 220 enables fault domain management for a distributed file system 341. As shown, the distributed file system 341 comprises a plurality of logical file systems (LFSs) 342A-342N having respective LFS database data 344A-344N in a distributed database 340. The LFSs 342A-342N also comprise respective non-database LFS data 346A-346N that is outside the distributed database 340. In the system layer architecture 300, each of the LFSs 342A-342N corresponds to a distinct fault domain. Further, without limitation to other examples, the distributed file system 341 and the distributed database 340 may be run as software on the same set of computers. For the architecture 300, the fault domain manager 230 may apply rules as described herein to assign, reassign, join, and/or disjoin fault domains (e.g., fault domains 242A-242N) corresponding to the logical file systems 342A-342N.

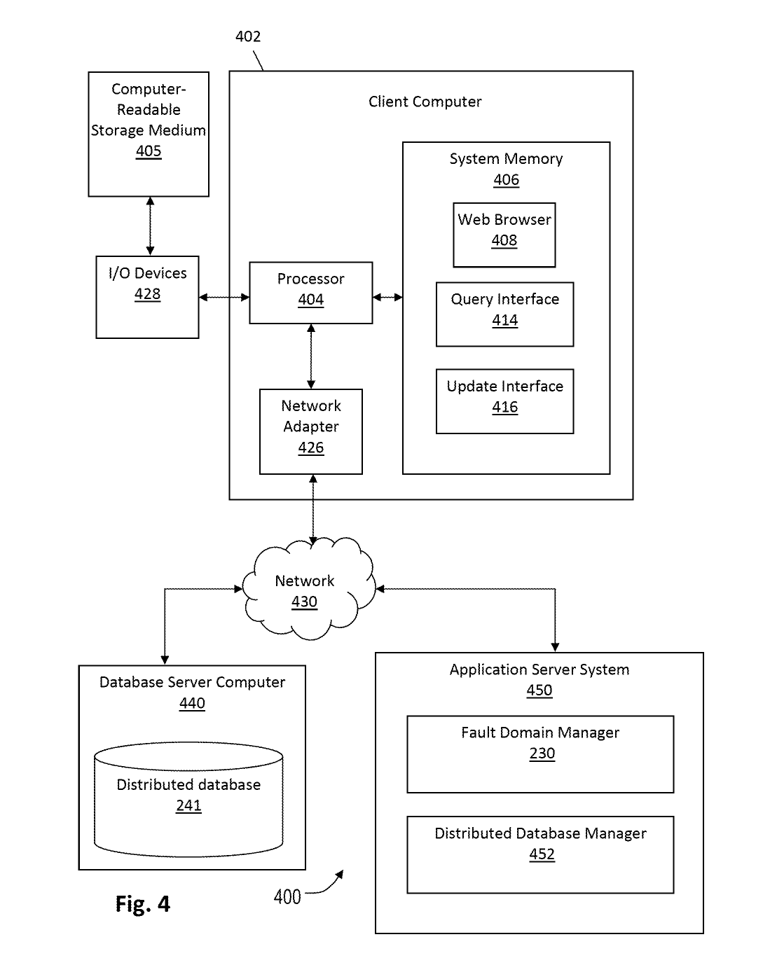

FIG. 4 shows a networked system 400 in accordance with an example of the disclosure. As shown, the networked system 400 comprises a client computer 402, an application server computer 450 and a database server computer 440 in communication via a network 430. In alternative embodiments, the operations of the client computer 402, the application server computer 450, and the database server computer 440 are combined on one computer, two computers, or more computers. In some embodiments, for example, the client computer operations and the application server computer operations may be combined on a single computer. Additionally or alternatively, the application server computer operations and the database server computer operations may be combined on a single computer.

In FIG. 4, the database server computer 440 comprises the distributed database 241 (or the distributed file system 341). Examples of the distributed database 241 or distributed file system 341 include, but are not limited to, a Metabox distributed database, or an IBRIX distributed file system. The information in the distributed database 241 includes data for each of the processing stages of the distributed database 241, including but not limited to, unsorted, id, sorted, merged and authority tables. The information in the distributed file system includes but is not limited to normal user files and/or the above distributed database files authority tables.

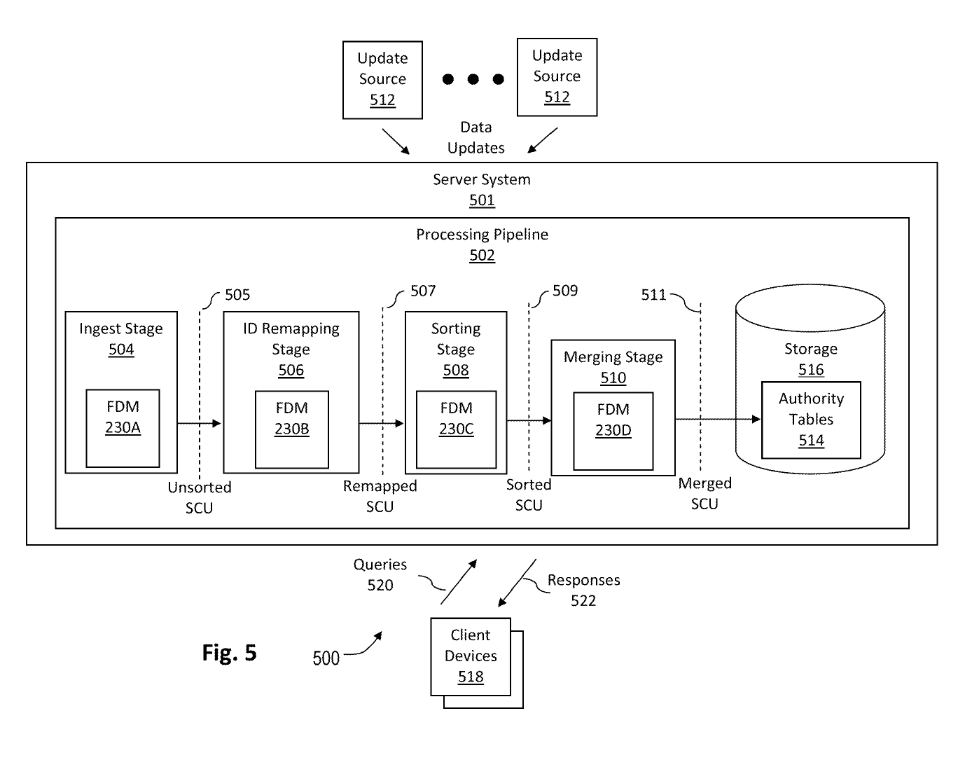

The application server computer 450 comprises the fault domain manager 230 described previously for the architectures 200 and 300, and a distributed database manager 452. The distributed database manager 452 may comprise various update processing stages that enable variations in the query response time and data freshness. As example of a processing pipeline 502 corresponding to the distributed database manager 452 is given hereafter in FIG. 5.

As shown in FIG. 4, the client computer 402 comprises a processor 404 (or processors) coupled to system memory 406. Some embodiments of the client computer 402 also include a network adapter 426 and I/O devices 428 coupled to the processor 404. The client computer 402 is representative of a desktop computer, a server computer, a notebook computer, a handheld computer, or a smart phone, etc., configured to communicate with server computers 440 and 450 via the network 430.

The processor 404 is configured to execute instructions read from the system memory 406. The processor 404 may be, for example, a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

In some examples, the system memory 406 corresponds to random access memory (RAM), which stores programs and/or data structures during runtime of the client computer 402. For example, during runtime of the client computer 402, the system memory 406 may store Web browser 408, a query interface 414 (e.g., corresponding to one of the query interfaces 214A-214N), and/or an update interface 416 (e.g., corresponding to one of the query interfaces 216A-214N) for execution by the processor 404 to perform the updates and/or queries described herein. The networked system 400 also may comprise a computer-readable storage medium 405, which corresponds to any combination of non-volatile memories such as semiconductor memory (e.g., flash memory), magnetic storage (e.g., a hard drive, tape drive, etc.), optical storage (e.g., compact disc or digital versatile disc), etc. The computer-readable storage medium 405 couples to I/O devices 428 in communication with the processor 404 for transferring data/code from the computer-readable storage medium 405 to the client computer 402. In some embodiments, the computer-readable storage medium 405 is locally coupled to I/O devices 428 that comprise one or more interfaces (e.g., drives, ports, etc.) to enable data to be transferred from the computer-readable storage medium 405 to the client computer 402 or the application server computer 450. Alternatively, the computer-readable storage medium 405 is part of a remote system (e.g., a server) from which data/code may be downloaded to the client computer 402 via I/O devices such as I/O devices 428. In such case, the I/O devices 428 may comprise networking components (e.g., network adapter 426). Regardless of whether the computer-readable storage medium 405 is local or remote to the client computer 402, the code and/or data structures stored in the computer-readable storage medium 405 are loaded into the system memory 406 for execution by the processor 404.

The I/O devices 428 also may comprise various devices employed by a user to interact with the processor 404 based on programming executed thereby. Exemplary I/O devices 428 include video display devices, such as liquid crystal, cathode ray, plasma, organic light emitting diode, vacuum fluorescent, electroluminescent, electronic paper or other appropriate display panels for providing information to the user. Such devices may be coupled to the processor 404 via a graphics adapter. Keyboards, touchscreens, and pointing devices (e.g., a mouse, trackball, light pen, etc.) are examples of devices includable in the I/O devices 428 for providing user input to the processor 404 and may be coupled to the processor 404 by various wired or wireless communications subsystems, such as Universal Serial Bus (USB) or Bluetooth interfaces.

A network adapter 426 may couple to the processor 404 to allow the processor 404 to communicate with server computers 440 and/or 450 via the network 430. For example, the network adapter 426 may enable the client computer 402 to submit updates to or acquire content (e.g., query results, metadata, reports, etc.) from the application server computer 450. As an example, the application server computer 450 may receive queries from the client computer 402. In response, the application server computer 450 may access the distributed database 241 based on the operations of the fault domain manager 230 and the distributed database manager 452. Thereafter, query results or related reports are returned to the client computer 402. The network adapter 426 may allow connection to a wired or wireless network, for example, in accordance with protocols such as IEEE 802.11, IEEE 802.3, Ethernet, cellular technologies, etc. The network 430 may comprise any available computer networking arrangement, for example, a local area network (“LAN”), a wide area network (“WAN”), a metropolitan area network (“MAN”), the internet, etc. Further, the network 430 may comprise any of a variety of networking technologies, for example, wired, wireless, or optical techniques may be employed. Accordingly, the server computers 440 and 450 are not restricted to any particular location or proximity to the client computer 402.

The discussion of components (e.g., processor 404, system memory 406, network adapter 426, I/O device 428, and computer-readable storage medium 405) related to the client computer 402 may be extended to the server computers 440 and/or 450. As an example, the fault domain manager 230 may have been retrieved from a computer-readable storage medium, such as computer-readable storage medium 405, and stored in a system memory of application server computer 450 for execution by a processor. In accordance with at least some embodiments, the network system 400 establishes and maintains fault domains for updates and/or queries to a distributed database as described herein.

FIG. 5 shows a pipelined database system 500 in accordance with an example of the disclosure. In the pipelined database system 500, a server system 501 employs a processing pipeline 502 to update a distributed database (e.g., distributed database 241) based on data updates from update sources 512. The server system 501 also employs the processing pipeline 502 to provide responses 522 to queries 520 received from client devices 518. Although not required, at least some of the client devices 518 may operate as update sources 512.

Without limitation to other examples, the pipelined data base system 500 may be used for an organization with a large amount of data that users or applications within the organization may request for purposes of data mining, analysis, search, and so forth. The data can span many different departments or divisions within the organization, and can be stored on various different types of devices, including desktop computers, notebook computers, email servers, web servers, file servers, and so forth. Examples of requests for data include electronic discovery requests, document requests by employees, requests made for information technology (IT) management operations, or other types of requests.

To improve the ability to locate the content of various data stored across an organization, metadata associated with such data from many information sources can be uploaded to a server system (or multiple server systems) to allow users to submit queries against the server system(s) to locate data based on the metadata. Examples of metadata that can be uploaded to the server system(s) include metadata computed based on content of the data, including hashes (produced by applying hash functions on data), term vectors (containing terms in the data), fingerprints, feature vectors. Other examples of metadata include filesystem metadata, such as file owners or creators, file size and security attributes, or information associated with usage of the data, such as access frequency statistics.

For the pipelined processor system 500, reference is made to one server system 501 for storing metadata (or other types of data). In alternative implementations, it is noted that there can be multiple server systems. Although reference is made to storing metadata in the server system 501, it is noted that other types of data may be stored in the server system 501. As used here, the term “data” can refer to any type of data, including actual data, metadata, or other types of information.

In a large organization, the server system 501 is designed to support data updates from multiple update sources 512 across the organization (e.g., up to hundreds of thousands or even millions for a large organization). A “data update” refers to a creation of data, modification of data, and/or deletion of data. Because there can be a relatively large amount of data updates to upload to the server system 501, it may take a relatively long period of time before the data updates are available for access via queries 520 submitted to the server system using conventional techniques.

Different applications have different data freshness specifications and different query performance goals. “Data freshness” refers to how up-to-date data should be for a response to a query. In some applications, a user may want a relatively quick response to a query, but the user may be willing to accept results that are out-of-date (e.g., out-of-date by a certain time period, such as 12 hours, one day, etc.). On the other hand, a virus scanning application may want an up-to-date response about content of various machines within the organization, but the virus scanning application may be willing to accept a slower response time to a query.

In accordance with some examples, the client devices 518 are able to submit queries 520 to the server system 501 with specified data freshness constraints and/or query performance goals. Based on the specified data freshness constraints and/or query performance goals, the server system 501 processes a query 520 accordingly. If data freshness is indicated to be important to a client device 518, then the server system 501 responds to a query 520 from the client device 518 by providing response data 522 that is more up-to-date. However, this may come at the expense of a longer query processing time. On the other hand, if the client device 518 specifies a lower level of data freshness but a higher query performance goal, then the server system 501 processes a query 520 by providing response data 522 that may not be up-to-date (e.g., the response data 522 may be up-to-date to within one day of the present time), but the response data 522 is provided to the requesting client device 518 in a shorter amount of time.

To vary the response capability of the server system 501, the processing pipeline 502 has multiple processing stages to perform different types of processing with respect to incoming data (data updates) that is to be stored in the server system 501. Without limitation to other examples, the processing pipeline 502 of the server system 100 comprises an ingest stage 504, an identifier (ID) remapping stage 506, a sorting stage 508, and a merging stage 510. Data updates from various update sources 512 are provided to the server system 500 for processing by the processing pipeline 502. Examples of the update sources 512 include various machines that can store data within an organization, where the machines can include desktop computers, notebook computers, personal digital assistants (PDAs), various types of servers (e.g., file servers, email servers, etc.), or other types of devices. Although specific stages of the processing pipeline 502 are depicted in FIG. 5, it is noted that in different examples alternative stages or additional stages can be provided in the processing pipeline 502.

A data update that is sent to the server system 501 can include the metadata associated with the data stored on the update sources 512, as discussed above. Alternatively, instead of metadata, actual data can be stored in the server system 501, such as various types of files, emails, video objects, audio objects, and so forth.

The processing pipeline 502 provides the ability to trade data freshness for query performance in the presence of ongoing data updates. The processing pipeline 502 achieves these goals through the use of a pipelined architecture that decreases data freshness but isolates query performance from ongoing updates. By being able to selectively access different ones of these stages depending upon the data freshness desired by the requesting client device, the processing pipeline 502 is able to trade some query performance for increased data freshness, or vice versa.

In some embodiments, multiple updates from one or more of the update sources 512 can be batched together into a batch that is to be atomically and consistently applied to an “authority table” 514 stored in a data store 516 of the server system 501. An authority table 514 refers to a repository of the data that is to be stored by the server system 501, where the authority table 514 is usually the table that is searched in response to a query for data. In some examples, the data store 516 can store multiple authority tables 514. The authority tables 514 are referred to as data tables, which are contained in a database. In other words, a “database” refers to a collection of data tables.

Another type of table that can be maintained by the server system 501 is an update table, which contains data that is to be applied to an authority table 514 after processing through the processing pipeline 502. The various processing stages (504, 506, 508, 510) are configured to process update tables.

The ingestion of updates by the server system 501 should leave the server system 501 in a consistent state, which means that all of the underlying tables affected by the updates are consistent with one another.

One update or multiple updates can be batched into a single self-consistent update (SCU) (more generally referred to as a “batch of updates”). The SCU is applied to tables stored in the server system 501 as a single atomic unit, and is not considered durable until all the individual updates in the batch (SCU) are written to stable (persistent) storage. Atomic application of data updates of an SCU to the stable storage means that all data updates of the SCU are applied or none are applied. Data updates in any one SCU are isolated from data updates in another SCU.

The ingest stage 504 of the processing pipeline 102 batches (collects) incoming updates from update sources 512 into one or more unsorted SCUs (or other types of data structures). In some embodiments, an unsorted SCU is durable, which means that the updates of the SCU are not lost upon some error condition or power failure of the server system 501. Moreover, by storing the data updates in the server system 501, the data updates are converted from being client-centric to server-centric.

As shown in FIG. 5, the output of the ingest stage 504 is an unsorted SCU (or multiple unsorted SCUs) 505. Each SCU includes one or more update tables containing update data. The unsorted SCU(s) 505 are provided to the ID remapping stage 506, which transforms initial (temporary) ID(s) of SCU(s) into global ID(s). Effectively, the ID remapping stage 506 maps an ID in a first space to an ID in a second space, which in some embodiments is a global space to provide a single, searchable ID space. The initial (temporary) IDs used by the ingest stage 504 are assigned to each unique entity (for example, file names) as those entities are processed. ID's are used in place of relatively large pieces of incoming data such as file path names, which improves query and processing times and reduces usage of storage space. In addition, in embodiments where the ingest stage 504 is implemented with multiple processors, temporary IDs generated by each of the processors can be remapped to the global ID space. In this way, the processors of the ingest stage 504 do not have to coordinate with each other to ensure generation of unique IDs, such that greater parallelism can be achieved. Note that as used here, a “processor” can refer to an individual central processing unit (CPU) or to a computer node.

The output of the ID remapping stage 506 includes one or more remapped SCUs 507 (within each remapped SCU, an initial ID has been remapped to a global ID). The remapped SCU 507 is provided to the sorting stage 508, which sorts one or more update tables in the remapped SCU 507 by one or more keys to create a sorted SCU 509 that contains one or more searchable indexes.

The output of the sorting stage 508 is a sorted SCU 509 (or multiple sorted SCUs 509), which is (are) provided to the merging stage 510. The merging stage 510 combines individual sorted SCUs into a single set of authority tables 514 to further improve query performance. The output of the merging stage 510 is represented as a merged SCU or SCUs 511.

In accordance with some examples, the various processing stages 504, 506, 508, and 510 of the processing pipeline 502 are individually and independently scalable. Each stage of the processing pipeline 502 can be implemented with a corresponding set of one or more processors, where a “processor” can refer to an individual central processing unit (CPU) or to a computer node. Parallelism in each stage can be enhanced by providing more processors. In this manner, the performance of each of the stages can be independently tuned by implementing each of the stages with corresponding infrastructure. Note that in addition to implementing parallelism in each stage, each stage can also implement pipelining to perform corresponding processing operations.

To process a query from a client device 518, the server system 501 may access just the authority tables 514, or alternatively, the server system 501 has the option of selectively accessing one or more of the processing stages 504, 506, 508, and 510 in the processing pipeline 502. The response time for processing a query is optimal when just the authority tables 514 have to be consulted to process a query. However, accessing just the authority tables 514 means that the response data retrieved may not be up-to-date (since there may be various data updates in the different stages of the processing pipeline 502).

To obtain fresher (more up-to-date data), the stages of the processing pipeline 502 can be accessed. However, having to access any of the processing stages in the processing pipeline 502 would increase the amount of time to process the query, with the amount of time increasing depending upon which of the processing stages are to be accessed. Accessing a later stage of the processing pipeline 502 involves less query processing time than accessing an earlier stage of the processing pipeline 502. For example, accessing content of sorted and merged update tables provided by the sorting and merging stages 508 and 510 takes less time than accessing the unsorted update tables maintained by the ingest stage 504 or the ID remapping stage 506. Moreover, accessing the ingest stage 504 may involve the additional operation of mapping a global ID to an initial ID that is kept by the ingest stage 504.

In some examples, the decision to access a particular stage of the processing pipeline 502 for processing a query may depend upon a data freshness constraint and query performance goal set by a client device 518. Increased data freshness means that the server system 501 should access earlier stages of the processing pipeline 502, while a higher performance goal means that the server system 501 should avoid accessing earlier stages of the processing pipeline 502 to retrieve response data for a query.

As noted above, in some examples, the server system 501 logically organizes data into authority tables and update tables each with an arbitrary number of named columns. Each table is stored using a primary view, which contains all of the data columns and is sorted on a key: an ordered subset of the columns in the table. For example, a table might contain three columns (A, B, C) and its primary view key can be (A, B), meaning the table is sorted first by A and then by B for equal values of A. Tables may also have any number of materialized secondary views that contain a subset of the columns in the table and are sorted on a different key.

SCUs are maintained as update tables of additions, modifications, and deletions, which are applied to the named authority tables. An update table has the same schema as the associated authority table, as well as additional columns to indicate the type of operation and a timestamp.

Over time, the updates received from update sources 518 are combined by the server system 501 to form an SCU. Updates are collected together until either a sufficient amount of time has passed (based on a timeout threshold) or a sufficient amount of data has been collected (based on some predefined size threshold). After either the timeout has occurred or the size threshold has been reached, new updates that are received are directed to the next SCU. Query freshness constraints can be satisfied by examining the SCUs that correspond to the desired point in time. Identifying SCUs for satisfying freshness constraints involves understanding the time to generate the SCU, the time to complete its processing throughout each stage of the processing pipeline 502 (pipeline processing latency), and the time to execute the query.

The time to generate an SCU depends on the arrival patterns of client updates, as well as the size threshold used to accumulate SCUs. Pipeline processing latency can be determined as a function of the steady-state throughput of each processing stage 504, 506, 508, and 510. Depending on when a query is issued and what its freshness specifications are, the server system 501 may choose the appropriate representation of the SCU (sorted or unsorted) to consult in satisfying the query. SCUs are applied as a single atomic unit, which leaves the database in a consistent state. The SCUs are not considered durable until all of the individual updates in the batch are written to stable storage. The use of SCUs also permits isolation between updates within a pipeline stage, and between queries and update ingestion. If the goal is to achieve per data source isolation, then SCUs can be formed with updates from a single data source only.

As noted above, the SCUs are applied in a time order. For example, each SCU can be associated with a timestamp indicating when the SCU was created. The timestamps of the SCUs can be employed to specify the order of applying the SCUs in the processing pipeline 502. In other implementations, other mechanisms for ordering the SCUs can be used. Ordering SCUs is easy in implementations where the ingest stage is implemented with just one processor (e.g., one computer node), such that the SCUs are serially applied. However, if the ingest stage 504 is implemented with multiple processors (e.g., multiple computer nodes), then ordering of SCUs becomes more complex. In provisioning the ingest stage, if enhanced parallelism is desired, then a more complex mechanism would have to be provided to assure proper ordering of the SCUs. On the other hand, reduced parallelism would involve less complex ordering mechanisms, but would result in an ingest stage having reduced performance.

Once the processing pipeline 502 provides data updates as an update data structure, such as an SCU, the update data structure may be transformed by one or more of the processing stages of the processing pipeline 502 into a form that allows for merging of the transformed update data structure into a database. The transforming includes one or more of: ID remapping, sorting, and merging. Next, the content of the transformed update data structure is stored into a database (e.g., the authority tables 514).

More specifically, data updates that are received by the processing pipeline 502, may be formed into an unsorted SCU by the ingest stage 504. The operation of the ingest stage 504 according to some examples is to organize received updates from update sources 512 into a form so that the data is both (1) durable and (2) available for query, albeit with potentially high query cost. In the ingest stage 504, updates are read from update sources 512 and written as rows into an unsorted primary view for the corresponding update table kept by the ingest stage 504. Rows of the primary view are assigned timestamps based on their ingestion time (used to resolve overwrites) and a flag indicating row deletion is set or unset (the flag is set if the key specified in this row should be removed from the database). ID keys in the updates are assigned initial IDs and the mapping from key to temporary ID is stored with the unsorted data. The combination of unsorted data and initial ID mappings results in an unsorted SCU that can be passed to the next stage (ID-remapping stage 506) of the pipeline 502.

Upon receiving the unsorted SCU from the ingest stage 504, the ID remapping stage 506 performs ID remapping by converting initial IDs to global IDs. To convert SCUs from using initial IDs to global IDs, a two-phase operation can be performed: ID-assignment and update-rewrite, which can be both pipelined and parallelized. In ID-assignment, the ID remapping stage 506 does a lookup on the keys in the SCU to identify existing keys and then assigns new global IDs to any unknown keys, generating an initial ID to global ID mapping for this update. A benefit of first checking for existing keys before assigning global IDs is that the relatively small size of the update dictates the size of the lookup, which enhances the likelihood of data processed by the ingest stage 504 can fit into physical memory. Thus, the lookup does not grow with the size of the server system 501 and, over time, will not dominate the ingest time. Because the ID-assignment phase does a lookup on a global key-space, this phase can be parallelized through the use of key-space partitioning.

The second phase, update-rewrite, involves rewriting the SCU with the correct global IDs. Because the mapping from initial ID to global ID is unique to the SCU being converted, any number of rewrites can be performed in parallel. The output of the ID remapping stage is a remapped SCU 507.

Next, sorting of the remapped SCU 507 is performed by the sorting stage 508. In some examples, the SCU's unsorted update tables are sorted by the sorting stage 508 using the appropriate key or keys. Update tables may have to be sorted in multiple ways, to match the primary and secondary views of the corresponding authority tables. Sorting is performed by reading the update table data to be sorted into memory and then looping through each view for that update table, sorting the data by the view's key. The resulting sorted data sets form the sorted SCU 509. The sorting stage 508 can be parallelized to nearly any degree. Because sorted data is merged in the next stage, sorting can take even a single table, break it into multiple chunks, and sort each chunk in parallel, resulting in multiple sorted output files.

Next, merging is performed by the merging stage 510. A sorted SCU 509 can be merged by the merging stage 510 into an authority table 514. Because the performance of queries 520 against sorted data is dictated primarily by the number of sorted update tables to search through, merging update tables together into fewer tables improves the query performance. Even merging two sorted update tables into a single sorted update table improves query performance. In some embodiments, tree-based parallelism is implemented in the merging stage 510. Rather than each sorted table being directly merged with the corresponding authority table, sets of update tables can be first merged together, and non-overlapping sets can be merged in parallel, forming a tree of updates working toward the “root,” which merges large sorted update tables with the authority table. The merge with the authority table, like ID-assignment, is a global operation, and can be parallelized through the use of key-space partitioning, in which the authority table is maintained as several table portions partitioned by key-space, allowing merges of separate key-spaces to proceed in parallel. Finally, merges to each of the individual authority views can also be executed in parallel.

In some embodiments, merging an update table into an authority table can be accomplished by performing a merge-join, in which the entire authority table is updated. However, if the authority table is large, then this operation can be relatively expensive, since potentially the entire authority table may have to be updated. A benefit of performing a merge using this technique is that the data in the authority table remains stored in sequential order on the underlying storage medium.

In alternative embodiments, an authority table can be divided into multiple extents, where each extent has a set of rows of data. To merge an update table into the authority table, the merging stage 510 first identifies the extents (usually some subset less than all of the extents of authority table) that are affected by the merge. The merge would then only rewrite the identified extents (thus the cost of the merge operation is based on the size of the update table and the distribution of keys in both the update table and the authority table, rather than the size of the authority table). The new extents (containing the merged old data and new data) can be added to the end of the authority table, for example. An index to the authority table can be updated to point to the new extents.

An issue of using the latter merge technique is that the extents in the authority table may no longer be in sequential order on the underlying storage medium. However, random access to the authority table does not suffer since an index can be used to quickly access the content of the authority table. Sequential access performance may potentially suffer, since if the authority table is stored on disk-based storage media, disk seeks may be involved in accessing logically consecutive data. To address this issue, an authority table rewrite can be performed to place the extents of the authority table in sequential order. The rewrite can be performed in the background, such as by another stage in the processing pipeline 502.

With respect to total system scalability, each of the processing stages of the processing pipeline 502 exhibit different scaling properties as described above. Ingest, sorting, and the update-rewrite phase of ID remapping are all linearly parallelizable with the number of processors used to implement the corresponding stage. Merging is log n parallelizable, where n is the fan-out of the merge tree. Finally, the ID-assignment phase of ID remapping and merging are both m-way parallelizable, where m is the number of partitions created in the key-space. The authority table merge is t-way parallelizable with t being the number of distinct views. The authority table merge is also m-way parallelizable.

To summarize, when the server system 501 receives a query 520, the server system 501 also may retrieve a data freshness constraint and a query performance goal. For example, the server system 501 may have kept the data freshness constraint and the query performance goal in storage of the server system 501, based on previous communication with a client device 518. Alternatively, the data freshness constraint and the query performance goal constraint can be submitted by a client device 518 along with the query 520.

The server system 501 then identifies which representations of data in the processing pipeline 502 to access based on the constraints (data freshness and query performance goal). The identified representations of data can include just authority tables 514, an unsorted SCU 505, a remapped SCU 507, a sorted SCU 509, and/or a merged SCU 511 respectively from the ingest stage 504, the ID-remapping stage 506, the sorting stage 508, and the merging stage 510. The response data 522 is then output from the server system 501 back to the client device 518 that submitted the corresponding query 520.

Without limitation to other examples, each stage of the processing pipeline 502 may comprise a plurality of processors connected by a link to each other and to storage media, which can include volatile storage (e.g., dynamic random access memories, static random access memories, etc.) and/or persistent storage (e.g., disk-based storage). The ingest stage 504 may include ingest software executable by processors or other logic to perform the ingest stage operations described herein. Further, the ID remapping stage 506 may include remapping software executable by processors or other logic to perform the remapping stage operations described herein. Further, the sorting stage 508 may include sorting software executable by processors or other logic to perform the sorting stage operations described herein. Further, the merging stage 510 may include merging software executable by processors or other logic to perform the merging stage operations described herein.

The number of processors in each of the processing stages 504, 506, 508, and 510 is individually and independently scalable. The number of processors for each stage can be independently chosen to tune the respective performance of the corresponding stages, and to meet any cost constraints. Also, the parallelism can be set on a per-SCU basis. For example, a large SCU would be allocated more resources than a small SCU in one or more of the stages in the processing pipeline 502.

As used herein, a “processor” can be a CPU or a computer node. In some examples, each stage (504, 506, 508, or 510) may be made up of a single computer node or multiple computer nodes. In such examples, the storage media in each stage may be local to each computer node (e.g., a disk drive in each computer node) or be shared across multiple computer nodes (e.g., a disk array or network-attached storage system). In one example, at least one of the stages 504, 506, 508, and 510 can be implemented with a set (cluster) of network-connected computer nodes, each with separate persistent storage. Each computer node in the cluster may or may not have multiple CPU's.

Instructions of software described above are loaded for execution of a processor or processors. Such processors may include microprocessors, microcontrollers, processor modules or subsystems (including one or more microprocessors or microcontrollers), computer nodes, or other control or computing devices.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the processing pipeline 502, each of the stages 504, 506, 508, and 510 comprises a respective fault domain manager (FDM) 230A-230D to perform the same or similar operations described previously for the control logic 104 of FIG. 1, or the fault domain manager 230 of FIGS. 2-4. Alternatively, a single fault domain manager 230 in communication with each stage of the processing pipeline 502 may perform the fault domain management operations described herein.

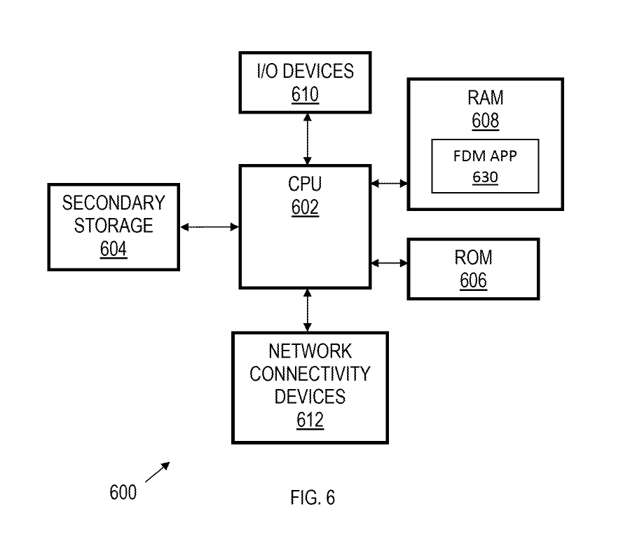

FIG. 6 shows an example of various components of a computer system 600 in accordance with the disclosure. The computer system 600 may perform various operations to support the fault domain management operations such as those described herein. Some or all of the components of the computer system 600 may be used to implement the distributed database 102, the control logic 104, the clients 212A-212N, the fault domain manager 230, the distributed database 241, the distributed file system 341, the client computer 402, the database server computer 440, the application server system 450, or the server system 501.

As shown, the computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. In the electrical engineering and software engineering arts, functionality that can be implemented by loading executable software into a computer can be converted to a hardware implementation by well-known design rules. Decisions between implementing a concept in software versus hardware may hinge on considerations of stability of the design and numbers of units to be produced rather than any issues involved in translating from the software domain to the hardware domain. Thus, a design that is still subject to frequent change may be implemented in software, because re-spinning a hardware implementation is more expensive than re-spinning a software design. Meanwhile, a design that is stable that is produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which may have a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk based systems may all be considered secondary storage 604), ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the computer 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

In some examples, a non-transitory computer-readable storage medium may store a fault domain manager (FDM) application 630 that, when executed, causes the processor 602 to perform the operations described for the fault domain manager 230. For example, the FDM application 630, when executed, may cause the processor 602 to receive updates to a distributed database and to apply identifiers to the updates to maintain distinct fault domains for the distributed database. The fault domain management application 630, when executed, also may cause the processor 602 to apply the same identifiers to queries for information from a distributed database in which fault domains have been applied.

In some examples, the FDM application 630, when executed, also may cause the processor 602 to join distinct fault domains or to disjoin previously joined fault domains. Further, the FDM application 630, when executed, also may cause the processor 602 to limit visibility of different fault domains according to a predetermined or customizable visibility scheme. Further, the FDM application 630, when executed, also may cause the processor 602 to collect metadata from a distributed file system and store the metadata in a logical file system and the distributed file system to enable origin-based data partitioning. Further, the FDM application 630, when executed, also may cause the processor 602 to apply separate migration and backup operations to an origin file system based on its expected fault behavior so that a fault domain has the same reliability semantics as the origin file system. Further, the FDM application 630, when executed, also may cause the processor 602 to any other operations described herein for setting up, maintaining, or updating fault domains for a distributed database.

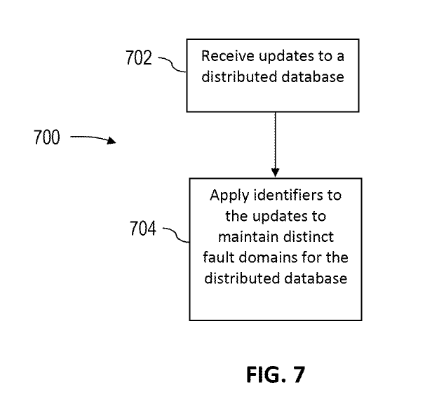

FIG. 7 shows a method 700 in accordance with an example of the disclosure. The method may be performed, for example, by control logic such as the control logic 104 of FIG. 1, by an application layer with a fault domain manager such as the application layer 220 of FIGS. 2 and 3, by an application server system with a fault domain manager such as the application server system 450 of FIG. 4, by a server system with a processing pipeline such as the server system 501 of FIG. 5, or by a processor (e.g., processor 602) executing fault domain management instructions.

As shown, the method 700 comprises receiving updates to a distributed database (block 702). The method 700 further comprises applying identifiers to the updates to maintain distinct fault domains for the distributed database (block 704). With the distinct fault domains provided by method 700, queries for information from the distributed database are based on the same identifiers applied to the updates.

In some examples, the method 700 comprises additional or alternative steps. For example, the method 700 may comprise joining distinct fault domains or disjoining previously joined fault domains. Further, the method 700 may comprise limiting visibility of different fault domains according to a predetermined or customizable visibility scheme. Further, the method 700 may comprise collecting metadata from a distributed file system and storing the metadata in a logical file system and the distributed file system to enable origin-based data partitioning. Further, the method 700 may comprise applying separate migration and backup operations to an origin file system based on its expected fault behavior so that a fault domain has the same reliability semantics as the origin file system. Further, the method 700 may comprise performing any other operations described herein for setting up, maintaining, or updating fault domains for a distributed database.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a distributed database; and
control logic to enable updates and queries to the distributed database,
wherein the control logic applies a plurality of identifiers to the updates and queries to maintain distinct fault domains in the distributed database.

2. The system of claim 1, wherein the distributed database comprises a pipelined database.

3. The system of claim 1, wherein the plurality of identifiers comprise metadata identifiers attached to batches of updates.

4. The system of claim 1, wherein different fault domains are assigned to different customers or applications.

5. The system of claim 1, wherein the control logic enables distinct fault domains to be joined.

6. The system of claim 1, wherein the control logic limits visibility of different fault domains according to a customizable visibility scheme.

7. The system of claim 1, wherein the distributed database is associated with a distributed file system and wherein each of the distinct fault domains is associated with a logical file system within the distributed file system.

8. The system of claim 7, wherein the plurality of identifiers correspond to a plurality of logical file systems within the distributed file system.

9. The system of claim 1, wherein the distributed database is associated with a distributed file system, wherein the distinct fault domains correspond to individual nodes running the distributed file system, and wherein updates are partitioned based on a location of data referred to in the update.

10. The system of claim 1, wherein the control logic ensures that metadata originating in a logical file system that is part of a distributed file system is stored back into that logical file system to enable origin-based data partitioning.

11. The system of claim 1, wherein the control logic applies separate migration and backup operations to an origin file system based on its expected fault behavior and wherein a fault domain has the same reliability semantics as the origin file system.

12. A method, comprising:
receiving, by a processor, updates to a distributed database; and
applying, by the processor, identifiers to the updates to maintain distinct fault domains across the distributed database.

13. The method of claim 12, further comprising limiting visibility of different fault domains according to a predetermined visibility scheme.

14. The method of claim 12, further comprising collecting metadata from a distributed file system and storing the metadata in a logical file system and the distributed file system to enable origin-based data partitioning.

15. The method of claim 12, further comprising applying separate migration and backup operations to an origin file system based on its expected fault behavior so that a fault domain has the same reliability semantics as the origin file system.

16. A pipelined database system, comprising:
a plurality of data update processing stages to enable trading off between query response time and data freshness;
control logic in communication with the plurality of data update processing stages to maintain distinct fault domains for the pipelined database system.

17. The pipelined database system of claim 16, wherein the plurality of data update processing stages comprises an ingest stage to output batched updates, and wherein the control logic applies at least one logical identifier to each batch to maintain the distinct fault domains for the pipelined database system.

18. The pipelined database system of claim 16, wherein the plurality of data update processing stages comprises an identifier (ID) remapping stage to output remapped update batches, and wherein the control logic applies at least one logical identifier to each remapped batch to maintain the distinct fault domains for the pipelined database system.

19. The pipelined database system of claim 16, wherein the plurality of data update processing stages comprises a sorting stage to output sorted update batches, and wherein the control logic applies at least one logical identifier to each sorted batch to maintain the distinct fault domains for the pipelined database system.

20. The pipelined database system of claim 16, wherein the plurality of data update processing stages comprises a merging stage to output merged update batches, and wherein the control logic applies at least one logical identifier to each merged batch to maintain the distinct fault domains for the pipelined database system.
